(19) United States
(12) Patent Application Publication
(10) Pub. No.: US 2025/0135853 A1
(43) Pub. Date: May 1, 2025

(54) Cargo Box Frame Assembly

(71) Applicant: Leer Group, Elkhart, IN (US)

(72) Inventor: Eugene A. Dylewski, II, Granger, IN (US)

(21) Appl. No.: 18/926,967

(22) Filed: Oct. 25, 2024

Related U.S. Application Data
(60) Provisional application No. 63/546,604, filed on Oct. 31, 2023.

(51) Int. Cl. B60J 7/16; B60R 9/02

(52) U.S. Cl. CPC B60J 7/1607; B60R 9/02

(57) ABSTRACT

A cargo box frame assembly is provided that includes a longitudinally extending frame member having an outwardly accessible accessory slot and an inwardly accessible accessory slot. The outwardly accessible accessory slot of a first side frame member is located adjacent the inwardly accessible accessory slot of the first side frame member. The outwardly accessible accessory slot of the first side frame member includes an opening and the inwardly accessible accessory slot of the first side frame member includes an opening. The opening of the outwardly accessible accessory slot of the first side frame member is positioned on an opposite side of the first side frame member from the opening of the inwardly accessible accessory slot of the first side frame member.

### RELATED APPLICATIONS

The present application relates to and claims priority to U.S. Provisional Patent application, Ser. No. 63/546,604, filed on Oct. 31, 2023, entitled “Modular Truck Cap.” The subject matter disclosed in that Provisional application is hereby expressly incorporated into the past Application.

### TECHNICAL FIELD AND DISCLOSURE OF ILLUSTRATIVE EMBODIMENTS

The present disclosure relates to trucks, such as pickup trucks, with truck beds or cargo boxes, and, in particular, to an assemblable frame to be placed on the top of the cargo box for use as an accessory frame assembly and/or a structural frame assembly for a cap.

Pickup truck cargo boxes are useful for carrying accessories such as tools, extra fuel, recreational equipment, lumber, etc. A truck cap is an enclosure that attaches to the top sidewalls of the pickup truck's cargo box. The truck cap includes upward extending sidewalls, forward wall, and a door, typically positioned on the rearward end above the pickup truck's tailgate (although the door can be placed anywhere on the cap). Typically, the upward extending walls terminate at the approximate height of the pickup truck's cab section roof. This configuration enhances the pickup truck's aesthetic appearance, similar to an SUV, while at the same time expanding the volume of under-roof storage space in the truck bed or cargo box.

An illustrative embodiment of the present disclosure provides an assemblable frame structure that can be assembled and attached to the top of a cargo box. The frame assembly can be used as an accessory frame for receiving various tool racks, boxes, brackets, hooks, etc. The frame assembly may also receive cap components such as sidewall and front window panels, a roof panel, and a door, to form a truck cap over the cargo box.

A further illustrative embodiment of the present disclosure provides a cargo box frame assembly. The cargo box frame assembly includes a longitudinally extending first side frame member having an outwardly accessible accessory slot that extends a longitudinal extent of the first side frame member and an inwardly accessible accessory slot that extends the longitudinal extent of the first side frame member; wherein the outwardly accessible accessory slot of the first side frame member is located adjacent the inwardly accessible accessory slot of the first side frame member; wherein the outwardly accessible accessory slot of the first side frame member includes an opening that extends the longitudinal extent of the first side frame member and has a width less than a width of the outwardly accessible accessory slot of the first side frame member; wherein the inwardly accessible accessory slot of the first side frame member includes an opening that extends the longitudinal extent of the first side frame member and has a width less than a width of the inwardly accessible accessory slot of the first side frame member; wherein the opening of the outwardly accessible accessory slot of the first side frame member is positioned on an opposite side of the first side frame member from the opening of the inwardly accessible accessory slot of the first side frame member; a longitudinally extending second side frame member that includes an outwardly accessible accessory slot that extends a longitudinal extent of the second side frame member and an inwardly accessible accessory slot that extends the longitudinal extent of the second side frame member; wherein the outwardly accessible accessory slot of the second side frame member is located adjacent the inwardly accessible accessory slot of the second side frame member; wherein the outwardly accessible accessory slot of the second side frame member includes an opening that extends the longitudinal extent of the second side frame member and has a width less than a width of the outwardly accessible accessory slot of the second side frame member; wherein the inwardly accessible accessory slot of the second side frame member includes an opening that extends the longitudinal extent of the second side frame member and has a width less than a width of the inwardly accessible accessory slot of the second side frame member; wherein the opening of the outwardly accessible accessory slot of the second side frame member is positioned on an opposite side of the second side frame member from the opening of the inwardly accessible accessory slot of the second side frame member; wherein the longitudinally extending second side frame member includes a second outwardly accessible accessory slot that extends the longitudinal extent of the second side frame member and a second inwardly accessible accessory slot that extends the longitudinal extent of the second side frame member; wherein the second outwardly accessible accessory slot of the second side frame member is located adjacent the second inwardly accessible accessory slot of the second side frame member; wherein the second outwardly accessible accessory slot of the second side frame member includes an opening that extends the longitudinal extent of the second side frame member and has a width less than a width of the second outwardly accessible accessory slot of the second side frame member; wherein the second inwardly accessible accessory slot of the second side frame member includes an opening that extends the longitudinal extent of the second side frame member and has a width less than a width of the second inwardly accessible accessory slot of the second side frame member; wherein the opening of the second outwardly accessible accessory slot of the second side frame member is positioned on an opposite side of the second side frame member from the opening of the second inwardly accessible accessory slot of the second side frame member; a first upwardly extending corner pillar that includes an outwardly accessible accessory slot that extends a longitudinal extent of the first upwardly extending corner pillar; wherein the outwardly accessible accessory slot of the first upwardly extending corner pillar is bounded by a first inwardly accessible accessory slot that extends the longitudinal extent of the first upwardly extending corner pillar and a second inwardly accessible accessory slot that extends the longitudinal extent of the first upwardly extending corner pillar; wherein the first inwardly accessible accessory slot of the first upwardly extending corner pillar and the second inwardly accessible accessory slot of the first upwardly extending corner pillar are located on an opposing side from the outwardly accessible accessory slot of the first upwardly extending corner pillar; wherein the first side frame member is spaced apart from the second side frame member and are both located adjacent the first upwardly extending corner pillar; a second upwardly extending corner pillar that includes an outwardly accessible accessory slot that extends a longitudinal extent of the second upwardly extending corner pillar; wherein the outwardly accessible accessory slot of the second upwardly extending corner pillar is bounded by a first inwardly accessible accessory slot that extends the longitudinal extent of the second upwardly extending corner pillar and a second inwardly accessible accessory slot that extends the longitudinal extent of the second upwardly extending corner pillar; wherein the first inwardly accessible accessory slot of the second upwardly extending corner pillar and the second inwardly accessible accessory slot of the second upwardly extending corner pillar are located on an opposing side from the outwardly accessible accessory slot of the second upwardly extending corner pillar; wherein the first side frame member and the second side frame member are both located adjacent the second upwardly extending corner pillar; a longitudinally extending third side frame member that includes an outwardly accessible accessory slot that extends a longitudinal extent of the third side frame member and an inwardly accessible accessory slot that extends the longitudinal extent of the third side frame member; wherein the outwardly accessible accessory slot of the third side frame member is located adjacent the inwardly accessible accessory slot of the third side frame member; wherein the outwardly accessible accessory slot of the third side frame member includes an opening that extends the longitudinal extent of the third side frame member and has a width less than a width of the outwardly accessible accessory slot of the third side frame member; wherein the inwardly accessible accessory slot of the third side frame member includes an opening that extends the longitudinal extent of the third side frame member and has a width less than a width of the inwardly accessible accessory slot of the third side frame member; wherein the opening of the outwardly accessible accessory slot of the third side frame member is positioned on an opposite side of the third side frame member from the opening of the inwardly accessible accessory slot of the third side frame member; a longitudinally extending fourth side frame member that includes an outwardly accessible accessory slot that extends a longitudinal extent of the fourth side frame member and an inwardly accessible accessory slot that extends the longitudinal extent of the fourth side frame member; wherein the outwardly accessible accessory slot of the fourth side frame member is located adjacent the inwardly accessible accessory slot of the fourth side frame member; wherein the outwardly accessible accessory slot of the fourth side frame member includes an opening that extends the longitudinal extent of the fourth side frame member and has a width less than a width of the outwardly accessible accessory slot of the fourth side frame member; wherein the inwardly accessible accessory slot of the fourth side frame member includes an opening that extends the longitudinal extent of the fourth side frame member and has a width less than a width of the inwardly accessible accessory slot of the fourth side frame member; wherein the opening of the outwardly accessible accessory slot of the fourth side frame member is positioned on an opposite side of the fourth side frame member from the opening of the inwardly accessible accessory slot of the fourth side frame member; wherein the fourth side frame member includes a second outwardly accessible accessory slot that extends a longitudinal extent of the fourth side frame member and a second inwardly accessible accessory slot that extends the longitudinal extent of the fourth side frame member; wherein the second outwardly accessible accessory slot of the fourth side frame member is located adjacent the second inwardly accessible accessory slot of the fourth side frame member; wherein the second outwardly accessible accessory slot of the fourth side frame member includes an opening that extends the longitudinal extent of the fourth side frame member and has a width less than a width of the second outwardly accessible accessory slot of the fourth side frame member; wherein the second inwardly accessible accessory slot of the fourth side frame member includes an opening that extends the longitudinal extent of the fourth side frame member and has a width less than a width of the second inwardly accessible accessory slot of the fourth side frame member; wherein the opening of the second outwardly accessible accessory slot of the fourth side frame member is positioned on an opposite side of the fourth side frame member from the opening of the second inwardly accessible accessory slot of the fourth side frame member; a third upwardly extending corner pillar that includes an outwardly accessible accessory slot that extends a longitudinal extent of the third upwardly extending corner pillar; wherein the outwardly accessible accessory slot of the third upwardly extending corner pillar is bounded by a first inwardly accessible accessory slot that extends the longitudinal extent of the third upwardly extending corner pillar and a second inwardly accessible accessory slot that extends the longitudinal extent of the third upwardly extending corner pillar; wherein the first inwardly accessible accessory slot of the third upwardly extending corner pillar and the second inwardly accessible accessory slot of the third upwardly extending corner pillar are located on an opposing side from the outwardly accessible accessory slot of the third upwardly extending corner pillar; wherein the third side frame member is spaced apart from the fourth side frame member and are both located adjacent the third upwardly extending corner pillar; a fourth upwardly extending corner pillar that includes an outwardly accessible accessory slot that extends a longitudinal extent of the fourth upwardly extending corner pillar; wherein the outwardly accessible accessory slot of the fourth upwardly extending corner pillar is bounded by a first inwardly accessible accessory slot that extends the longitudinal extent of the fourth upwardly extending corner pillar and a second inwardly accessible accessory slot that extends the longitudinal extent of the fourth upwardly extending corner pillar; wherein the first inwardly accessible accessory slot of the fourth upwardly extending corner pillar and the second inwardly accessible accessory slot of the fourth upwardly extending corner pillar are located on an opposing side from the outwardly accessible accessory slot of the fourth upwardly extending corner pillar; wherein the third side frame member and the fourth side frame member are both located adjacent the fourth upwardly extending corner pillar; a longitudinally extending first end frame member that includes an outwardly accessible accessory slot that extends a longitudinal extent of the first end frame member; wherein the outwardly accessible accessory slot of the first end frame member is bounded by a first inwardly accessible accessory slot that extends the longitudinal extent of the first end frame member and a second inwardly accessible accessory slot that extends the longitudinal extent of the first end frame member; wherein the outwardly accessible accessory slot of the first end frame member is located on an opposing side of the first inwardly accessible accessory slot of the first end frame member and the second inwardly accessible accessory slot of the first end frame member; wherein the second upwardly extending corner pillar is located adjacent to the first end frame member; wherein the third upwardly extending corner pillar is located adjacent to the first end frame member opposite the second upwardly extending corner pillar; and a longitudinally extending second end frame member that includes an outwardly accessible accessory slot that extends a longitudinal extent of the second end frame member; wherein the outwardly accessible accessory slot of the second end frame member is bounded by a first inwardly accessible accessory slot that extends the longitudinal extent of the second end frame member and a second inwardly accessible accessory slot that extends the longitudinal extent of the second end frame member; wherein the outwardly accessible accessory slot of the second end frame member is located on an opposing side of the first inwardly accessible accessory slot of the second end frame member and the second inwardly accessible accessory slot of the second end frame member; wherein the fourth upwardly extending corner pillar is located adjacent to the second end frame member; and wherein the first upwardly extending corner pillar is located adjacent to the second end frame member opposite the fourth upwardly extending corner pillar.

In the above and other illustrative embodiments, the cargo box frame assembly may further comprise: the first side frame member and the third side frame member each have a base configured to set on top of a sidewall of the cargo box; the outwardly accessible accessory slot and the inwardly accessible accessory slot of the second side frame member are located transverse to the second outwardly accessible accessory slot and the second inwardly accessible accessory slot of the second side frame member; the outwardly accessible accessory slot and the inwardly accessible accessory slot of the fourth side frame member are located transverse to the second outwardly accessible accessory slot and the second inwardly accessible accessory slot of the fourth side frame member; the second upwardly extending corner pillar is connectable to the first end frame member and the third upwardly extending corner pillar is connectable to the first end frame member opposite the second upwardly extending corner pillar; the fourth upwardly extending corner pillar is connectable to the second end frame member and the first upwardly extending corner pillar is connectable to the second end frame member opposite the fourth upwardly extending corner pillar; the first side frame member and the third side frame member are each a base frame member; the second side frame member and the fourth side frame member are each a top frame member; the outwardly accessible accessory slot and the inwardly accessible accessory slot both of the first side frame member share a common wall; each of the outwardly accessible accessory slot and the inwardly accessible accessory slot from each of the first side frame member, the second side frame member, the third side frame member, and the fourth side frame member are configured to receive a respective movable block wherein the movable block disposed in the outwardly accessible accessory slot is attachable to a bracket and the movable block disposed within the inwardly accessible accessory slot is attachable to a truck cap panel member; the outwardly accessible accessory slot and the inwardly accessible accessory slot of the first side frame member are located at least about parallel to the outwardly accessible accessory slot and the inwardly accessible accessory slot of the second side frame member; the second side frame member and the fourth side frame member each includes a support panel extending from the second inwardly accessible accessory slot of the second side frame member and the fourth side frame member, respectively; and the first end frame member and the second end frame member each includes a support panel extending from the second inwardly accessible accessory slot of the first end frame member and the second end frame member, respectively.

Another illustrative embodiment of the present disclosure provides a cargo box frame assembly. The cargo box frame assembly includes a longitudinally extending first side frame member having an outwardly accessible accessory slot that extends a longitudinal extent of the first side frame member and an inwardly accessible accessory slot that extends the longitudinal extent of the first side frame member; wherein the outwardly accessible accessory slot of the first side frame member is located adjacent the inwardly accessible accessory slot of the first side frame member; wherein the outwardly accessible accessory slot of the first side frame member includes an opening that extends the longitudinal extent of the first side frame member and has a width less than a width of the outwardly accessible accessory slot of the first side frame member; wherein the inwardly accessible accessory slot of the first side frame member includes an opening that extends the longitudinal extent of the first side frame member and has a width less than a width of the inwardly accessible accessory slot of the first side frame member; wherein the opening of the outwardly accessible accessory slot of the first side frame member is positioned on an opposite side of the first side frame member from the opening of the inwardly accessible accessory slot of the first side frame member; a longitudinally extending second side frame member that includes an outwardly accessible accessory slot that extends a longitudinal extent of the second side frame member and an inwardly accessible accessory slot that extends the longitudinal extent of the second side frame member; wherein the outwardly accessible accessory slot of the second side frame member is located adjacent the inwardly accessible accessory slot of the second side frame member; wherein the outwardly accessible accessory slot of the second side frame member includes an opening that extends the longitudinal extent of the second side frame member and has a width less than a width of the outwardly accessible accessory slot of the second side frame member; wherein the inwardly accessible accessory slot of the second side frame member includes an opening that extends the longitudinal extent of the second side frame member and has a width less than a width of the inwardly accessible accessory slot of the second side frame member; wherein the opening of the outwardly accessible accessory slot of the second side frame member is positioned on an opposite side of the second side frame member from the opening of the inwardly accessible accessory slot of the second side frame member; wherein the longitudinally extending second side frame member includes a second outwardly accessible accessory slot that extends the longitudinal extent of the second side frame member and a second inwardly accessible accessory slot that extends the longitudinal extent of the second side frame member; wherein the second outwardly accessible accessory slot of the second side frame member is located adjacent the second inwardly accessible accessory slot of the second side frame member; wherein the second outwardly accessible accessory slot of the second side frame member includes an opening that extends the longitudinal extent of the second side frame member and has a width less than a width of the second outwardly accessible accessory slot of the second side frame member; wherein the second inwardly accessible accessory slot of the second side frame member includes an opening that extends the longitudinal extent of the second side frame member and has a width less than a width of the second inwardly accessible accessory slot of the second side frame member; and wherein the opening of the second outwardly accessible accessory slot of the second side frame member is positioned on an opposite side of the second side frame member from the opening of the second inwardly accessible accessory slot of the second side frame member.

In the above and other illustrative embodiments, the cargo box frame assembly may further comprise: a first upwardly extending corner pillar that includes an outwardly accessible accessory slot that extends a longitudinal extent of the first upwardly extending corner pillar, wherein the outwardly accessible accessory slot of the first upwardly extending corner pillar is bounded by a first inwardly accessible accessory slot that extends the longitudinal extent of the first upwardly extending corner pillar and a second inwardly accessible accessory slot that extends the longitudinal extent of the first upwardly extending corner pillar; wherein the first inwardly accessible accessory slot of the first upwardly extending corner pillar and the second inwardly accessible accessory slot of the first upwardly extending corner pillar are located on an opposing side from the outwardly accessible accessory slot of the first upwardly extending corner pillar; wherein the first side frame member is spaced apart from the second side frame member and are both located adjacent the first upwardly extending corner pillar, and a second upwardly extending corner pillar that includes an outwardly accessible accessory slot that extends a longitudinal extent of the second upwardly extending corner pillar, wherein the outwardly accessible accessory slot of the second upwardly extending corner pillar is bounded by a first inwardly accessible accessory slot that extends the longitudinal extent of the second upwardly extending corner pillar and a second inwardly accessible accessory slot that extends the longitudinal extent of the second upwardly extending corner pillar, wherein the first inwardly accessible accessory slot of the second upwardly extending corner pillar and the second inwardly accessible accessory slot of the second upwardly extending corner pillar are located on an opposing side from the outwardly accessible accessory slot of the second upwardly extending corner pillar, and wherein the first side frame member and the second side frame member are both located adjacent the second upwardly extending corner pillar.

In the above and other illustrative embodiments, the cargo box frame assembly may further comprise: a longitudinally extending third side frame member that includes an outwardly accessible accessory slot that extends a longitudinal extent of the third side frame member and an inwardly accessible accessory slot that extends the longitudinal extent of the third side frame member, wherein the outwardly accessible accessory slot of the third side frame member is located adjacent the inwardly accessible accessory slot of the third side frame member, wherein the outwardly accessible accessory slot of the third side frame member includes an opening that extends the longitudinal extent of the third side frame member and has a width less than a width of the outwardly accessible accessory slot of the third side frame member, wherein the inwardly accessible accessory slot of the third side frame member includes an opening that extends the longitudinal extent of the third side frame member and has a width less than a width of the inwardly accessible accessory slot of the third side frame member, wherein the opening of the outwardly accessible accessory slot of the third side frame member is positioned on an opposite side of the third side frame member from the opening of the inwardly accessible accessory slot of the third side frame member, and a longitudinally extending fourth side frame member that includes an outwardly accessible accessory slot that extends a longitudinal extent of the fourth side frame member and an inwardly accessible accessory slot that extends the longitudinal extent of the fourth side frame member, wherein the outwardly accessible accessory slot of the fourth side frame member is located adjacent the inwardly accessible accessory slot of the fourth side frame member, wherein the outwardly accessible accessory slot of the fourth side frame member includes an opening that extends the longitudinal extent of the fourth side frame member and has a width less than a width of the outwardly accessible accessory slot of the fourth side frame member, wherein the inwardly accessible accessory slot of the fourth side frame member includes an opening that extends the longitudinal extent of the fourth side frame member and has a width less than a width of the inwardly accessible accessory slot of the fourth side frame member, wherein the opening of the outwardly accessible accessory slot of the fourth side frame member is positioned on an opposite side of the fourth side frame member from the opening of the inwardly accessible accessory slot of the fourth side frame member, wherein the fourth side frame member includes a second outwardly accessible accessory slot that extends a longitudinal extent of the fourth side frame member and a second inwardly accessible accessory slot that extends the longitudinal extent of the fourth side frame member, wherein the second outwardly accessible accessory slot of the fourth side frame member is located adjacent the second inwardly accessible accessory slot of the fourth side frame member, wherein the second outwardly accessible accessory slot of the fourth side frame member includes an opening that extends the longitudinal extent of the fourth side frame member and has a width less than a width of the second outwardly accessible accessory slot of the fourth side frame member, wherein the second inwardly accessible accessory slot of the fourth side frame member includes an opening that extends the longitudinal extent of the fourth side frame member and has a width less than a width of the second inwardly accessible accessory slot of the fourth side frame member, and wherein the opening of the second outwardly accessible accessory slot of the fourth side frame member is positioned on an opposite side of the fourth side frame member from the opening of the second inwardly accessible accessory slot of the fourth side frame member.

In the above and other illustrative embodiments, the cargo box frame assembly may further comprise: a third upwardly extending corner pillar that includes an outwardly accessible accessory slot that extends a longitudinal extent of the third upwardly extending corner pillar, wherein the outwardly accessible accessory slot of the third upwardly extending corner pillar is bounded by a first inwardly accessible accessory slot that extends the longitudinal extent of the third upwardly extending corner pillar and a second inwardly accessible accessory slot that extends the longitudinal extent of the third upwardly extending corner pillar, wherein the first inwardly accessible accessory slot of the third upwardly extending corner pillar and the second inwardly accessible accessory slot of the third upwardly extending corner pillar are located on an opposing side from the outwardly accessible accessory slot of the third upwardly extending corner pillar, wherein the third side frame member is spaced apart from the fourth side frame member and are both located adjacent the third upwardly extending corner pillar, and a fourth upwardly extending corner pillar that includes an outwardly accessible accessory slot that extends a longitudinal extent of the fourth upwardly extending corner pillar, wherein the outwardly accessible accessory slot of the fourth upwardly extending corner pillar is bounded by a first inwardly accessible accessory slot that extends the longitudinal extent of the fourth upwardly extending corner pillar and a second inwardly accessible accessory slot that extends the longitudinal extent of the fourth upwardly extending corner pillar, wherein the first inwardly accessible accessory slot of the fourth upwardly extending corner pillar and the second inwardly accessible accessory slot of the fourth upwardly extending corner pillar are located on an opposing side from the outwardly accessible accessory slot of the fourth upwardly extending corner pillar, and wherein the third side frame member and the fourth side frame member are both located adjacent the fourth upwardly extending corner pillar.

In the above and other illustrative embodiments, the cargo box frame assembly may further comprise: a longitudinally extending first end frame member that includes an outwardly accessible accessory slot that extends a longitudinal extent of the first end frame member, wherein the outwardly accessible accessory slot of the first end frame member is bounded by a first inwardly accessible accessory slot that extends the longitudinal extent of the first end frame member and a second inwardly accessible accessory slot that extends the longitudinal extent of the first end frame member, wherein the outwardly accessible accessory slot of the first end frame member is located on an opposing side of the first inwardly accessible accessory slot of the first end frame member and the second inwardly accessible accessory slot of the first end frame member, wherein the second upwardly extending corner pillar is located adjacent to the first end frame member, and wherein the third upwardly extending corner pillar is located adjacent to the first end frame member opposite the second upwardly extending corner pillar.

Another illustrative embodiment of the present disclosure provides a cargo box frame assembly. The cargo box frame assembly includes a longitudinally extending frame member having an outwardly accessible accessory slot and an inwardly accessible accessory slot; wherein the outwardly accessible accessory slot of a first side frame member is located adjacent the inwardly accessible accessory slot of the first side frame member; wherein the outwardly accessible accessory slot of the first side frame member includes an opening; wherein the inwardly accessible accessory slot of the first side frame member includes an opening, and wherein the opening of the outwardly accessible accessory slot of the first side frame member is positioned on an opposite side of the first side frame member from the opening of the inwardly accessible accessory slot of the first side frame member.

In the above and other illustrative embodiments, the cargo box frame assembly may further comprise: the opening of the outwardly accessible accessory slot has a width less than a width of the outwardly accessible accessory slot, wherein the opening of the inwardly accessible accessory slot has a width less than a width of the inwardly accessible accessory slot, and wherein the opening of the outwardly accessible accessory slot is positioned on an opposite side of the first side frame member from the opening of the inwardly accessible accessory slot.

Additional features and advantages of the cargo box frame assembly will become apparent to those skilled in the art upon consideration of the following detailed descriptions of carrying out this cargo box frame assembly as presently perceived.

### BRIEF DESCRIPTION OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a perspective view of a cargo box frame assembly;

FIG. 2 is an exploded perspective view of the cargo box frame assembly with truck cap panels;

FIG. 3 is a perspective view of the cargo box frame assembly with the cap panels installed thereon;

FIG. 4 is a cross-sectional view of the interior front and side portions of the cargo box frame assembly assembled into a truck cap;

FIG. 5 is a side perspective view of a portion of the cargo box frame assembly with the cap members coupled thereto;

FIG. 6 is a cross-sectional perspective view of front and side portions of the frame assembly and cap panels;

FIG. 7 is a perspective side view of the cargo box frame assembly and cap panels;

FIG. 8 is another perspective side view of the cargo box frame assembly and cap panels;

FIG. 9 is a profile end view of frame components of the cargo box frame assembly;

FIG. 10 is a profile end view of a base frame component of the cargo box frame assembly;

FIG. 11 is a profile end view of a top frame component of the cargo box frame assembly;

FIG. 12 is a profile end view of an end frame component of the cargo box frame assembly; and

FIG. 13 is a profile end view of a pillar frame component of the cargo box frame assembly.

Corresponding reference characters indicate corresponding parts throughout the several views. The exemplification set out herein illustrates embodiments of the cargo box top frame assembly and such exemplification is not to be construed as limiting the scope of the cargo box top frame assembly in any manner.

### DETAILED DESCRIPTION OF THE DRAWINGS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

An illustrative embodiment of the present disclosure provides an assemblable frame structure that can be attached to the top of a cargo box. The frame assembly may be used as an accessory frame for receiving various tool racks, boxes, brackets, hooks, etc. The frame assembly may also receive cap components such as sidewall panels, front window panels, roof panel(s), and a door, to form a truck cap over the cargo box. The frame members may include accessory channels or tracks extending the length of the frame (or a portion of the length of the frame) and on opposite sides of the frame. Such frame members may be made from an extruded material such as a metal or polymer that forms the slots or tracks on opposing sides thereof. Tracks, slots, or channels on the outer side of the frame can be used to attach accessories to be located exterior of the pickup truck. The opposing tracks, slots, or channels facing interior of the cargo box can be used to attach truck cap components or interior accessories. It is appreciated that in some design embodiments, portions of the truck cap body can be attached to outer tracks as well.

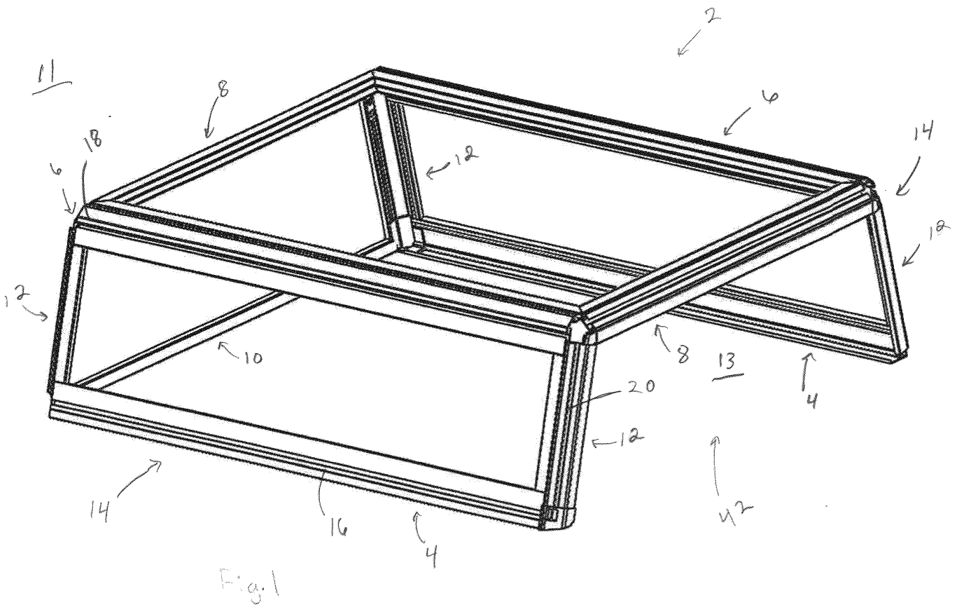

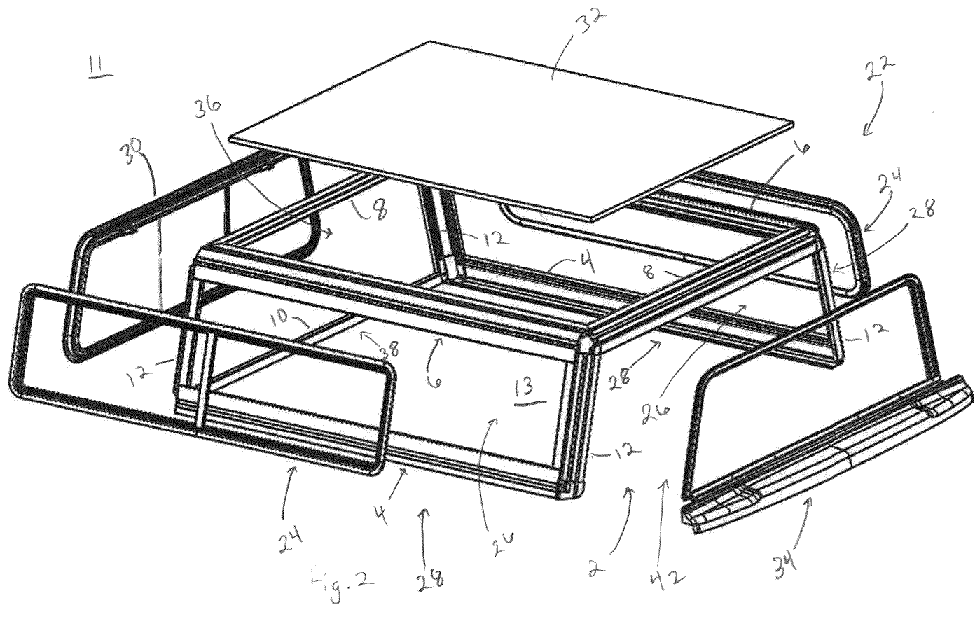

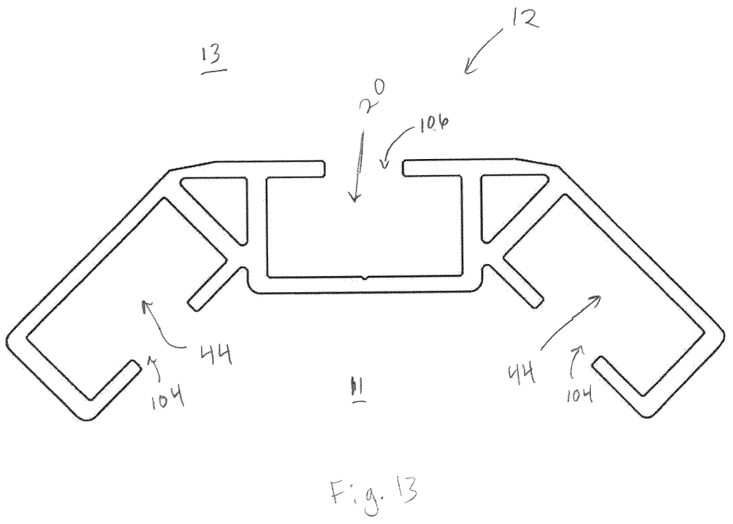

A perspective view of a cargo box frame assembly 2 is shown in FIG. 1. Cargo box frame assembly 2 is composed of frame rail extrusions 4, 6, 8, and 10 and pillar extrusions 12. Illustratively, side frame assemblies 14 can be identical on each side of the cargo box frame assembly 2 to reduce the number of different parts. To that end, only three additional rail members, 8 and 10, at the front and one rail member 8 at the rear, all extending between the side frame assemblies, may illustratively be employed to create cargo box frame assembly 2. This view shows exterior accessory tracks 16 and 18 of rails 4 and 8, respectively, that can be slots extending essentially the length of the rails. Likewise, pillars 12 have accessory tracks 20 as well. It is appreciated that exterior oriented accessory tracks are open to an exterior side 11 of cargo box frame assembly 2. These accessory track configurations are repeated on interior side 13 of the rails and pillars for purposes of attaching components of a truck cap (see, also, FIGS. 2 and 13) or interior accessories. Brackets or other like members can use the accessory tracks to attach adjacent frame members together to form cargo box frame assembly 2, as shown.

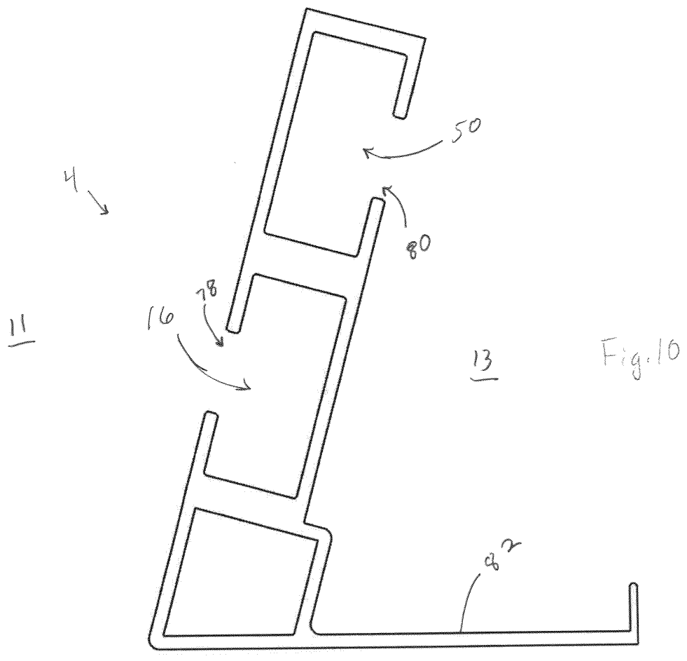

With accessory tracks 4 and 6 at both the top and bottom exterior of the frame, respectively, there are numerous opportunities to attach any variety of accessories such as racks, toolboxes, brackets, supplies, etc. to exterior side 11 of cargo box frame assembly 2. Likewise, in interior side 13 of cargo box frame assembly 2, there are also corresponding top and bottom accessory tracks on the side frame assemblies (see, also, FIGS. 10-13), which can be used to attach components of a truck cap or other accessories within the confines of the frame assembly. Like on the exterior, these accessory tracks can extend a portion of or the entire length of the interior side of the rail members.

An exploded perspective view of cargo box frame assembly 2, with truck cap panel assembly 22. is shown in FIG. 2. It is appreciated that side window sections 24 can be fitted within openings 26 created by the side frame assemblies 28, composed of rails 4 and 6, with multiple pillars 12. The same is also the case with front window section 30 and roof panel 32. It is appreciated that roof panel 32 can be a single sheet, multiple sheets, or a folded sheet. The cap panel assembly 22 can fit within the openings formed by the extrusion profile. Rear door 34 can be pivotally attached to top rear rail 8 of the cargo box frame assembly 2.

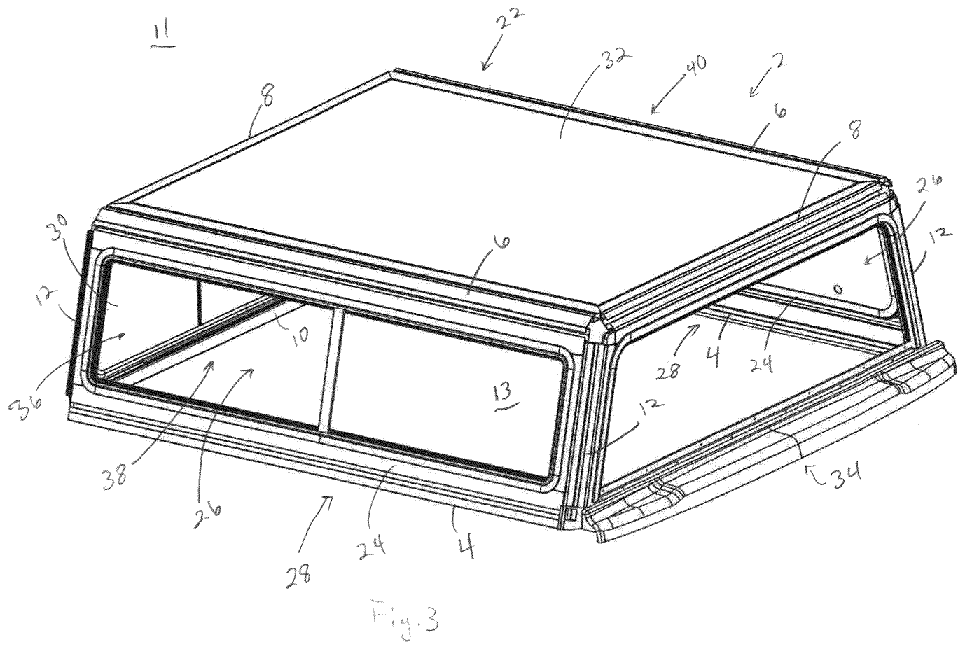

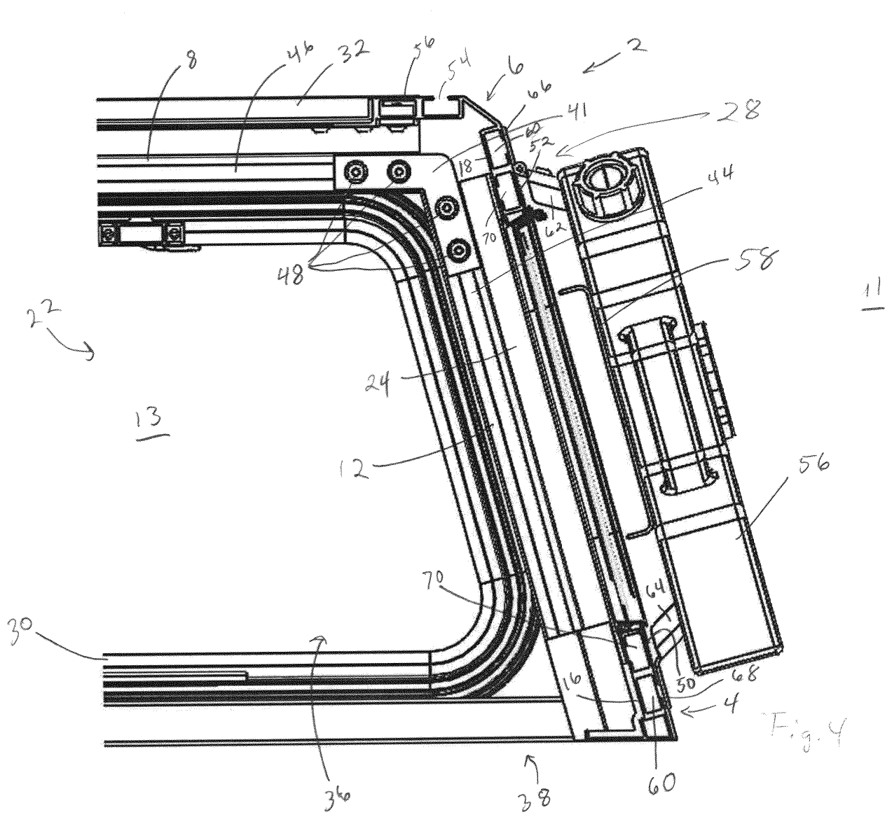

A perspective view of cargo box frame assembly 2, with cap panel assembly 22 installed thereon, is shown in FIG. 3. Here, side window sections 24 are fitted within openings 26 of side frame assemblies 28; front window section 30 is secured within opening 36 of front frame assembly 38, composed of rail members 8 and 10, as well as pillars 12; roof panel 32 is fitted within top frame assembly 40, composed of top rail members 6, 8; and rear door 34 is secured to rear frame assembly 42, composed of top frame 8 and pillars 12, to form a full truck cap. It is appreciated from this view that the exterior accessory tracks (see, also, FIGS. 4-13) are accessible on frame rails 4, 6, 8, 10, and pillars 12, to allow attachment of various accessories thereto. In this illustrative embodiment, having accessory tracks extend along the lengths of all of frame members 4, 6, 8, and 10, and pillars 12, provide almost limitless attachment options and opportunities for accessories.

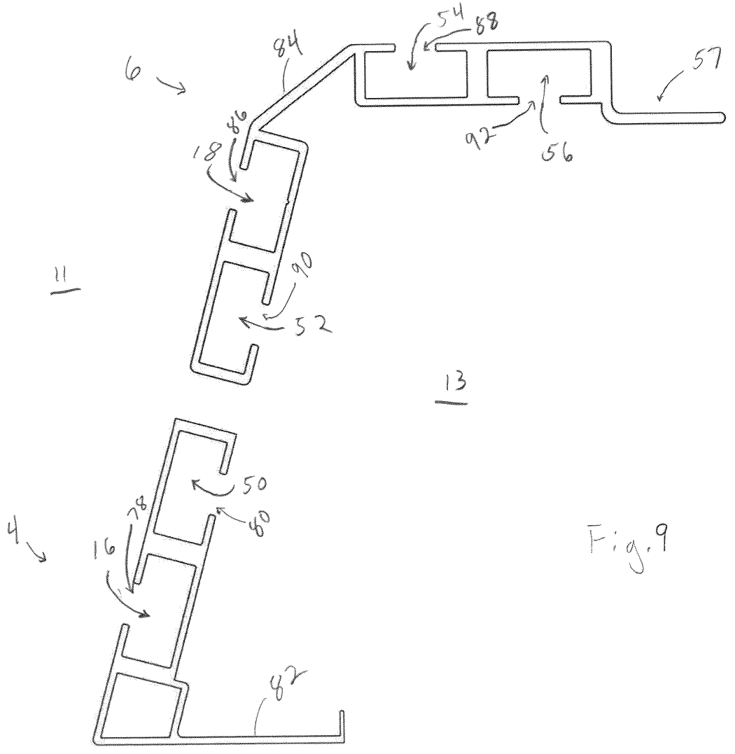

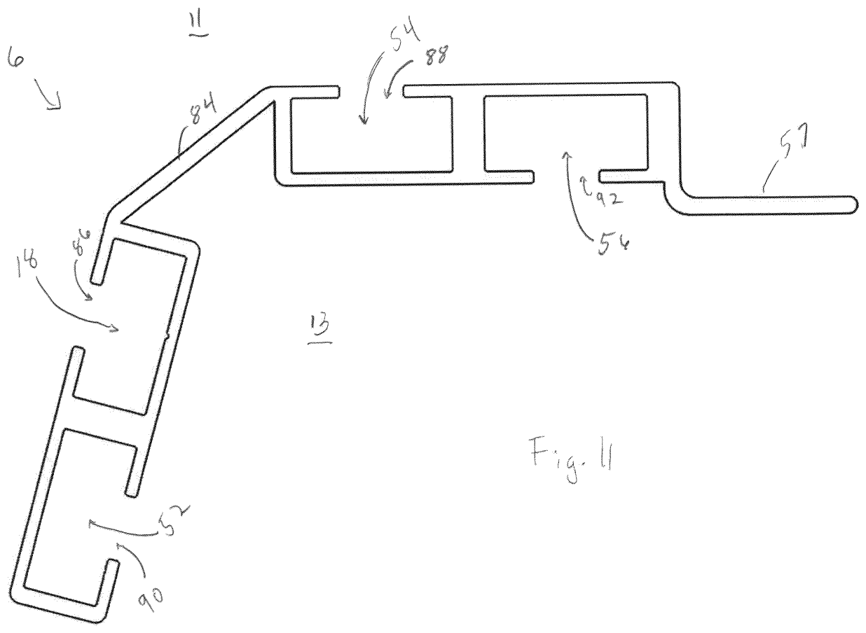

A cross-sectional view showing the interior front and side portions of cargo box frame assembly 2, with cap panel assembly 22 assembled to form a truck cap, is shown in FIG. 4. Here, an angle or attachment bracket 41 may be, illustratively, attached to interior accessory tracks 44 and 46 of pillar 12 and rail 8, respectively, to secure them together, illustratively, via fasteners 48. Such bracket attachment may be employed at the other corners of intersecting portions of cargo box frame assembly 2 as well. Also shown is front window section 30 fitted within opening 36 of front frame assembly 38 and rails 4 and 6 of side cargo box frame assembly 28. As further shown, rails 4 and 6 may include accessory tracks located on opposite sides of each other, extending therealong. Base rail 4 provides accessory tracks 16 and 50 to both exterior side 11 and interior side 13, respectively, of cargo box frame assembly 2. In addition to engaging roof panel 32, top rail members 6 includes accessory tracks 18 and 52 on one side of the angled body, as well as accessory tracks 54 and 56 on the other side of the angled body (see, also, FIGS. 9 and 11).

Also shown in this view is fuel can 56 secured to an accessory bracket 58, which itself is coupled to accessory tracks 18 and 16 of rails 6 and 4, respectively, via accessory blocks 60. Legs 62 and 64 of accessory bracket 58 may include feet 66 and 68, respectively, which secure to respective accessory blocks 60 to hold accessory bracket 58 and the attached gas can 56 to rail members 4 and 6 of cargo box frame assembly 2.

From interior side 13 of cargo box frame assembly 2, as illustratively shown, side window 24 can be secured to rail members 4 and 6 via attachment to blocks 70 located within accessory tracks 50 and 52, respectively. Additionally, and not shown in this view, by the same mechanism, blocks 70 can be fit into accessory track 44 of pillar 12 (see, also, FIG. 13) in order to further secure side window sections 24 to cargo box frame assembly 2. Likewise, roof panel 32 can sit on ledge 57 of rail member 6 and secure thereto in order to serve as a roof structure of the truck cap.

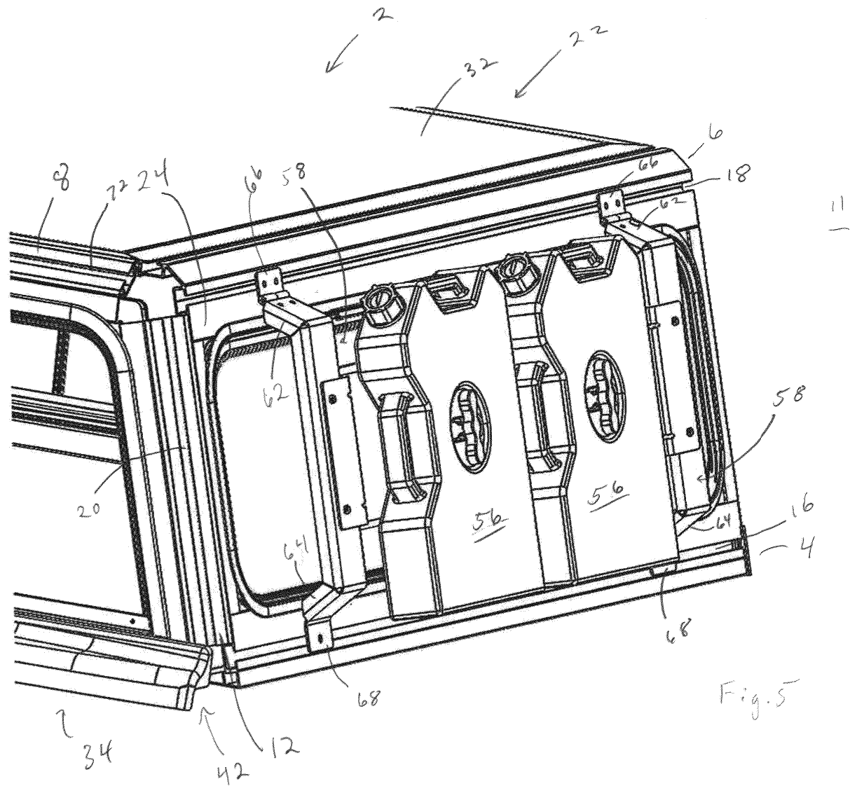

A side perspective view of a portion of cargo box frame assembly 2, with cap panel assembly 22 coupled thereto, is shown in FIG. 5. This view demonstrates how accessories, such as accessory brackets 58 with fuel cans 56, can be secured to accessory tracks 18 and 16 of top and bottom rails 6 and 4, respectively. This view demonstrates the utility of having accessory tracks both above and below window opening 26 of cargo box frame assembly 2. Spanning this distance allows larger objects to be attached to the sidewall of the cap. It is contemplated that such accessories may be added and removed at will, as determined by the operator.

This view also illustratively demonstrates how foot 66 is positioned over accessory track 18 to be secured to block 60 (see, also, FIG. 4), and is hingedly coupled to leg 62 in order to space a portion of bracket 58 from side window section 24. Similarly, foot 68 is located over accessory track 16 coupling thereto via block 60 (see, also, FIG. 4) and extends to leg 64 of accessory bracket 58. It is appreciated that any variety of accessories, toolholders, etc., can be attached to accessory bracket 58 for purposes of carrying those articles on the side of cargo box frame assembly 2 even with cap frame assemblies 22 secured thereon to form a truck cap. It is appreciated that such brackets as accessory bracket 58 or other accessory brackets can be positioned anywhere along either one or both of accessory tracks 18 and/or 16, as needed by the operator. The same is the case with accessory track 54 located on the top of rail member 6 adjacent roof panel 32, as well as accessory track 72 of rail member 8 and accessory track 20 of pillar 12. Blocks, such as accessory block 60, can be fitted within accessory tracks 54, 20, or 72, for example, in order to secure a bracket or accessory to those structures of cargo box frame assembly 2. Lastly, shown in this view is cap pillar 12 hingedly attached to rear frame assembly 42 composed of rail member 8 and pillars 12.

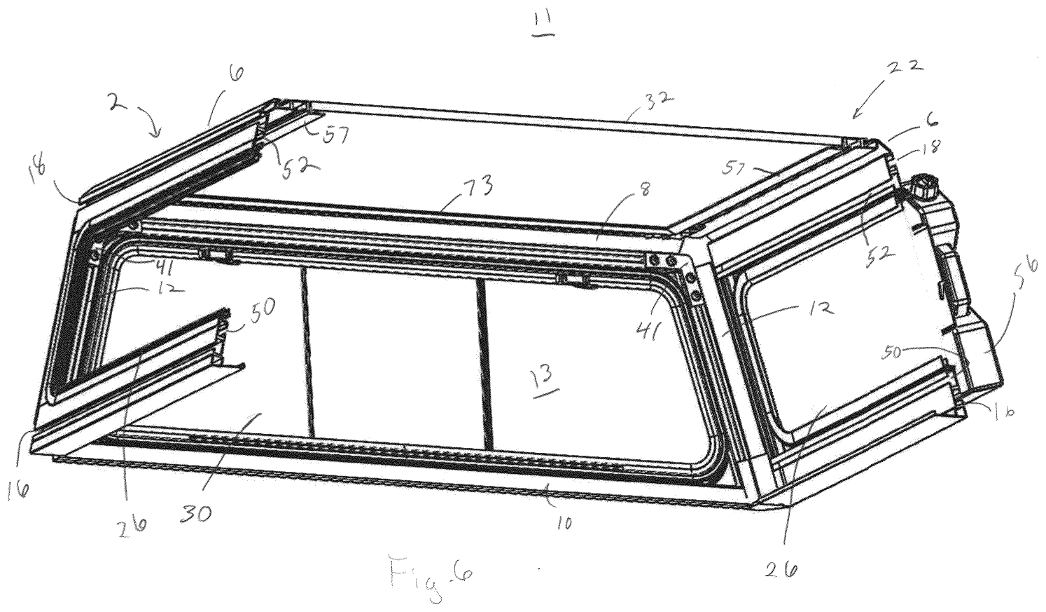

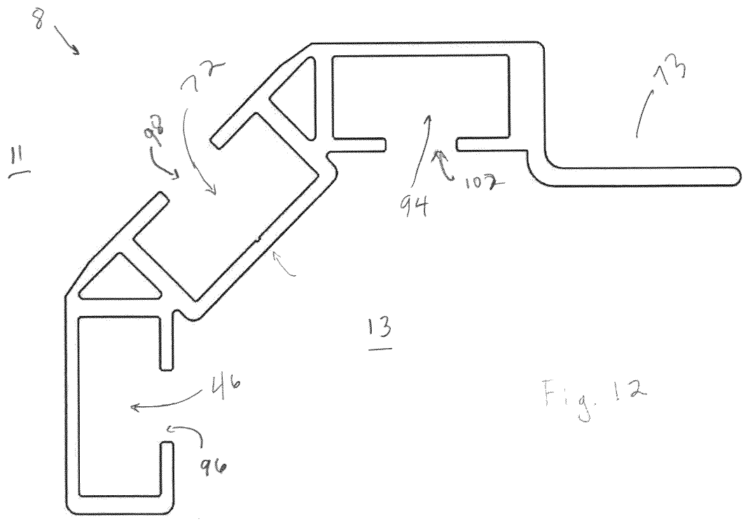

A cross-sectional perspective view of the front portion of cargo box frame assembly 2 and cap panel assembly 22 is shown in FIG. 6. This view demonstrates how the accessory tracks extending along the extrusion of side rail members 4 and 6 of cargo box frame assembly 2 face both outwardly and inwardly of same. This includes top end rails 8, as well as pillars 12. Illustratively, front window section 30 can be secured to rails 8 and 10, via clips or other like attachment means. Also shown in this view are attachment brackets 41 securing pillars 12 to rail 8 to hold cargo box frame assembly 2 together. In the illustrative embodiment, top rail members 8 are angled as shown having inwardly and outwardly directed accessory slots located on each side of the angled vertex (see, also, FIG. 12.)

Also shown in this view is roof panel 32, supported by ledge 57 of rail 6, as well as ledge 73 of rail member 8. It is appreciated that roof panel 32 may be fastened or otherwise secured to these ledge structures. It is further appreciated, however, that in other embodiments, ledges 57 of rail members 6 and/or ledges 73 of rail members 8, may support other structures such as cross beams or other rails for purposes of attaching accessories thereon.

This view further illustrates how the rail members when assembled as cargo box frame assembly 2, have accessory tracks extended outward of cargo box frame assembly 2, such as accessory tracks 16 and 18 of rail members 4 and 6, respectively, while also having inwardly directed tracks such as accessory tracks 50 and 52. This provides significant versatility in attaching panels to interior accessible accessory tracks directed to interior side 13, while at the same time allowing accessories to attach to the exterior accessible accessory tracks on exterior side 11. It is appreciated that other accessories can also be attached to the interior accessible accessory tracks as desired by the operator.

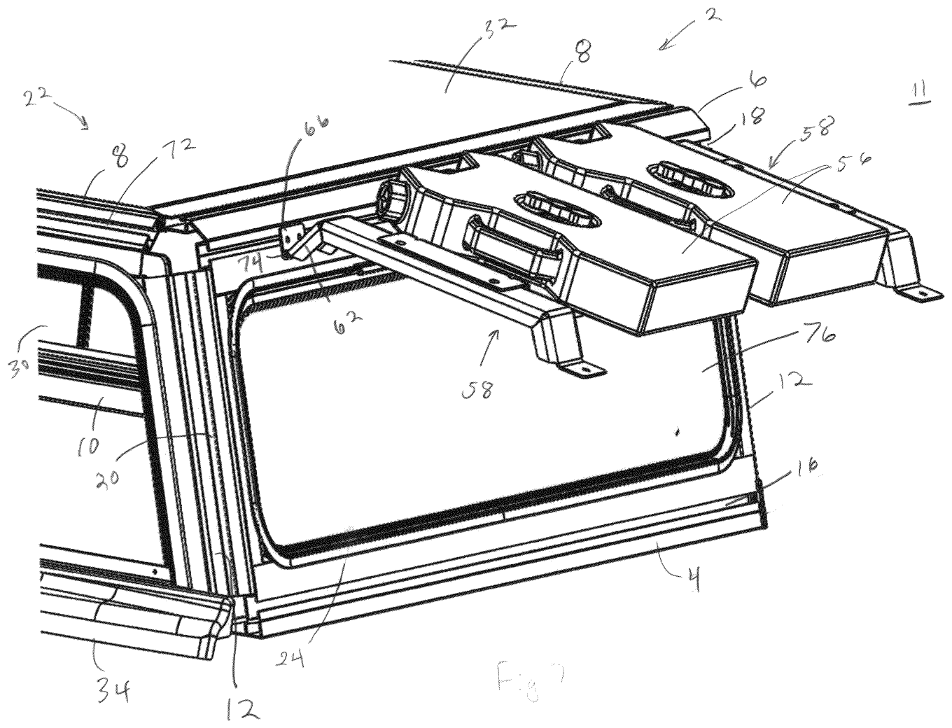

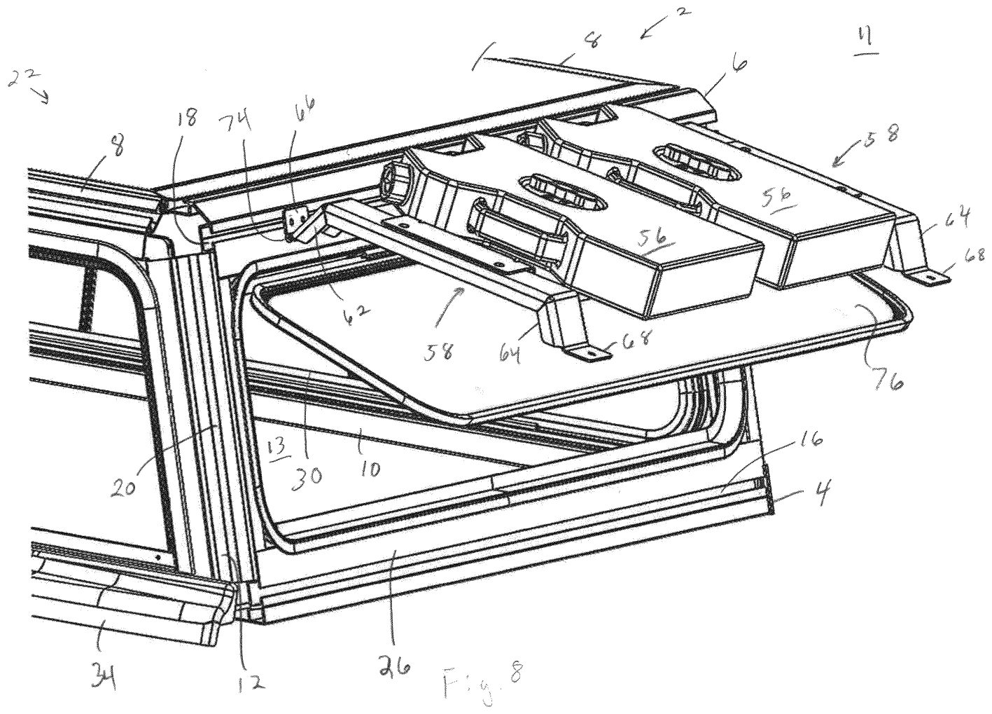

Perspective side views of cargo box frame assembly 2, with cap panels attached thereto forming cap panel assembly 22, are shown in FIGS. 7 and 8. The view in FIG. 7 shows fuel can bracket 58, which is attachable to both top rail 6 and base rail 4 on each side of side window openings 26 pivoted upward via a hinge 74 as part of foot 66 and leg 62. This allows access to side windoor 76 underneath. The view in FIG. 8 is the same as that in FIG. 7 except that windoor 76 can open and close as desired. It is further appreciated from these views how both pillars 12 and rails 4, 6, and 8 of cargo box frame assembly 2 include accessory tracks to provide almost limitless attachment options for any variety of accessories.

End profile views of the various frame members used to construct cargo box frame assembly 2 are shown in FIGS. 9-13. It is appreciated from these views how the alternating inwardly and outwardly directed accessory tracks are integrally formed in the rail members and pillars. It is also appreciated that the openings in these accessory tracks illustratively have narrower widths than the tracks themselves. It is further appreciated that in other embodiments these widths can be wider (even as wide as the accessory track) or narrower. These tracks can be used for both attaching accessories onto or connecting rails and pillars to each other. Thus, these open slots that form accessories tracks being alternately oriented can perform multiple roles.

End profile views of base rail 4 and top side rail 6 are shown in FIG. 9. Both of these rails may be employed to form window openings 26 for side window sections 24. This view demonstrates the modularity of cargo box frame assembly 2 by employing adjacent accessory slots that are accessible in opposite directions from each other. As shown with respect to base rail 4, accessory track 16 includes opening 78 configured to be accessible from exterior side 11 of cargo box frame assembly 2. In contrast, accessory track 50 includes an opening 80 accessible from interior side 13 of cargo box frame assembly 2. These opposed accessible accessory tracks can serve different purposes. For example, and as previously demonstrated, the interior accessible accessory tracks, such as accessory track 50, can receive blocks or other securing structures to attach to truck cap panel assembly 22, such as side window sections 24, as previously demonstrated. It will be appreciated by the skilled artisan upon reading this disclosure that other truck cap panels, brackets, etc., may be secured to interior accessible accessory tracks, while leaving the externally accessible accessory tracks available for brackets or other structures intended to be accessed exterior of the cargo box. Base rail member 4 also includes a base panel 82, which is configured to set on the sidewall of the cargo box which provides the support for cargo box frame assembly 2.

Similarly, top rail member 6 includes adjacent outwardly and inwardly accessible accessory tracks 18 and 52, respectively. In addition, a corner member 84 attaches those accessory tracks with accessory tracks 54 and 56 along with ledge 57. Both outwardly accessible accessory tracks 18 and 54 included openings 86 and 88, respectively, whereas inwardly accessible accessory tracks 52 and 56 included openings 90 and 92, respectively. Inwardly accessible accessory tracks 52 and 56, as previously demonstrated and appreciated, can receive blocks or other like structures to secure to truck cap panels, such as side window panel section 24 or other accessories, for access interior of the cargo box. Exterior accessible accessory tracks 18 and 54 can receive blocks or other attachment structures to secure accessories or brackets thereon as desired by the operator. Ledge 57, extending from accessory track 56, as demonstrated previously, supports roof panel 32. It is further appreciated that ledge 57 may be employed for supporting other structures such as cross beams or rails that can hold other accessories.

An isolated end profile view of base rail member 4 is shown in FIG. 10. This view further demonstrates how the adjacent opposingly accessible accessory tracks provide versatility for an operator to use the space above the cargo box as desired.

An isolated end profile view of top rail member 6 is shown in FIG. 11. It is appreciated from this view how top rail member 6 provides a set of adjacent oppositely accessible accessory tracks 18 and 52 directed to the side and adjacent oppositely directed accessory tracks 54 and 56 directed to the top and are attached together via corner member 84. This functionality of adjacent accessory tracks 54 and 56 are available in addition to ledge 57, which itself can hold roof panel 32 or other accessories thereon.

An end view of end rail member 8 is shown in FIG. 12. End rail member 8 may be used at the leading top edge or the trailing top edge of cargo box frame assembly 2. Although end rail member 8 only includes an illustrative single outwardly accessible accessory track 72, the configuration of adjacent interiorly accessible and exteriorly accessible accessory tracks is still provided. For example, interior opening 96 of accessory track 46 is oriented opposite of exteriorly accessible opening 98 of accessory track 72. Similarly, interiorly oriented opening 102 of accessory track 94 is also located adjacent exteriorly accessible opening 98 of accessory track 72. Both accessory tracks 46 and 94, in this case, are adjacent the single accessory track 72. Therefore, adjacent, oppositely accessible accessory tracks are provided with this rail as well. Similar to top rail member 6, end rail member 8 is oriented with accessory tracks located perpendicular to each other. Here, accessory track 46 and accessory track 94 are perpendicular to each other, with the commonly shared accessory track 72 extending therebetween in an angled orientation similar to corner member 84 of rail member 6. With this angled orientation of accessory track 72, attachment points can still be made therealong exteriorly leading or trailing the end of cargo box frame assembly 2. Lastly, a ledge 73 extends from accessory track 94 and is directed inwardly of the cargo box for purposes of supporting roof panel 32, similar to ledge 57 of rail member 6, or other cross beams or accessory tracks.

An end profile view of pillar 12 is shown in FIG. 13. Like end rail member 8, pillar 12 includes adjacent inwardly accessible accessory tracks 44 to outwardly accessible accessory track 20 located therebetween. Openings 104 of inwardly accessible accessory tracks 44 are located opposite outwardly accessible opening 106 of accessory track 20. It is appreciated, based on the preceding disclosure, that the faces of openings 104 on each side of accessory track 20 are substantially orthogonal to each other so as to provide additional attachment points for interior structures such as side window sections 24 and/or front window section 30. At the same time, accessory track 20 is accessible on exterior side 11 of cargo box frame assembly 2 and available to receive attaching accessory structures as well.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that any subject matter disclosed in this non-provisional patent application that may differ from the priority application, the disclosure from this non-provisional patent application controls.

What is claimed:

1. A cargo box frame assembly configured to set on top of a cargo box of a pickup truck, the cargo box frame assembly comprising:
a longitudinally extending first side frame member that includes an outwardly accessible accessory slot that extends a longitudinal extent of the first side frame member and an inwardly accessible accessory slot that extends the longitudinal extent of the first side frame member;
wherein the outwardly accessible accessory slot of the first side frame member is located adjacent the inwardly accessible accessory slot of the first side frame member;
wherein the outwardly accessible accessory slot of the first side frame member includes an opening that extends the longitudinal extent of the first side frame member and has a width less than a width of the outwardly accessible accessory slot of the first side frame member;
wherein the inwardly accessible accessory slot of the first side frame member includes an opening that extends the longitudinal extent of the first side frame member and has a width less than a width of the inwardly accessible accessory slot of the first side frame member;
wherein the opening of the outwardly accessible accessory slot of the first side frame member is positioned on an opposite side of the first side frame member from the opening of the inwardly accessible accessory slot of the first side frame member;
a longitudinally extending second side frame member that includes an outwardly accessible accessory slot that extends a longitudinal extent of the second side frame member and an inwardly accessible accessory slot that extends the longitudinal extent of the second side frame member;
wherein the outwardly accessible accessory slot of the second side frame member is located adjacent the inwardly accessible accessory slot of the second side frame member;
wherein the outwardly accessible accessory slot of the second side frame member includes an opening that extends the longitudinal extent of the second side frame member and has a width less than a width of the outwardly accessible accessory slot of the second side frame member;
wherein the inwardly accessible accessory slot of the second side frame member includes an opening that extends the longitudinal extent of the second side frame member and has a width less than a width of the inwardly accessible accessory slot of the second side frame member;
wherein the opening of the outwardly accessible accessory slot of the second side frame member is positioned on an opposite side of the second side frame member from the opening of the inwardly accessible accessory slot of the second side frame member;
wherein the longitudinally extending second side frame member includes a second outwardly accessible accessory slot that extends the longitudinal extent of the second side frame member and a second inwardly accessible accessory slot that extends the longitudinal extent of the second side frame member;
wherein the second outwardly accessible accessory slot of the second side frame member is located adjacent the second inwardly accessible accessory slot of the second side frame member;
wherein the second outwardly accessible accessory slot of the second side frame member includes an opening that extends the longitudinal extent of the second side frame member and has a width less than a width of the second outwardly accessible accessory slot of the second side frame member;
wherein the second inwardly accessible accessory slot of the second side frame member includes an opening that extends the longitudinal extent of the second side frame member and has a width less than a width of the second inwardly accessible accessory slot of the second side frame member;
wherein the opening of the second outwardly accessible accessory slot of the second side frame member is positioned on an opposite side of the second side frame member from the opening of the second inwardly accessible accessory slot of the second side frame member;
a first upwardly extending corner pillar that includes an outwardly accessible accessory slot that extends a longitudinal extent of the first upwardly extending corner pillar;
wherein the outwardly accessible accessory slot of the first upwardly extending corner pillar is bounded by a first inwardly accessible accessory slot that extends the longitudinal extent of the first upwardly extending corner pillar and a second inwardly accessible accessory slot that extends the longitudinal extent of the first upwardly extending corner pillar;
wherein the first inwardly accessible accessory slot of the first upwardly extending corner pillar and the second inwardly accessible accessory slot of the first upwardly extending corner pillar are located on an opposing side from the outwardly accessible accessory slot of the first upwardly extending corner pillar;
wherein the first side frame member is spaced apart from the second side frame member and are both located adjacent the first upwardly extending corner pillar;
a second upwardly extending corner pillar that includes an outwardly accessible accessory slot that extends a longitudinal extent of the second upwardly extending corner pillar;
wherein the outwardly accessible accessory slot of the second upwardly extending corner pillar is bounded by a first inwardly accessible accessory slot that extends the longitudinal extent of the second upwardly extending corner pillar and a second inwardly accessible accessory slot that extends the longitudinal extent of the second upwardly extending corner pillar;
wherein the first inwardly accessible accessory slot of the second upwardly extending corner pillar and the second inwardly accessible accessory slot of the second upwardly extending corner pillar are located on an opposing side from the outwardly accessible accessory slot of the second upwardly extending corner pillar;
wherein the first side frame member and the second side frame member are both located adjacent the second upwardly extending corner pillar;
a longitudinally extending third side frame member that includes an outwardly accessible accessory slot that extends a longitudinal extent of the third side frame member and an inwardly accessible accessory slot that extends the longitudinal extent of the third side frame member;
wherein the outwardly accessible accessory slot of the third side frame member is located adjacent the inwardly accessible accessory slot of the third side frame member;
wherein the outwardly accessible accessory slot of the third side frame member includes an opening that extends the longitudinal extent of the third side frame member and has a width less than a width of the outwardly accessible accessory slot of the third side frame member;
wherein the inwardly accessible accessory slot of the third side frame member includes an opening that extends the longitudinal extent of the third side frame member and has a width less than a width of the inwardly accessible accessory slot of the third side frame member;
wherein the opening of the outwardly accessible accessory slot of the third side frame member is positioned on an opposite side of the third side frame member from the opening of the inwardly accessible accessory slot of the third side frame member;
a longitudinally extending fourth side frame member that includes an outwardly accessible accessory slot that extends a longitudinal extent of the fourth side frame member and an inwardly accessible accessory slot that extends the longitudinal extent of the fourth side frame member;
wherein the outwardly accessible accessory slot of the fourth side frame member is located adjacent the inwardly accessible accessory slot of the fourth side frame member;
wherein the outwardly accessible accessory slot of the fourth side frame member includes an opening that extends the longitudinal extent of the fourth side frame member and has a width less than a width of the outwardly accessible accessory slot of the fourth side frame member;
wherein the inwardly accessible accessory slot of the fourth side frame member includes an opening that extends the longitudinal extent of the fourth side frame member and has a width less than a width of the inwardly accessible accessory slot of the fourth side frame member;
wherein the opening of the outwardly accessible accessory slot of the fourth side frame member is positioned on an opposite side of the fourth side frame member from the opening of the inwardly accessible accessory slot of the fourth side frame member;
wherein the fourth side frame member includes a second outwardly accessible accessory slot that extends a longitudinal extent of the fourth side frame member and a second inwardly accessible accessory slot that extends the longitudinal extent of the fourth side frame member;
wherein the second outwardly accessible accessory slot of the fourth side frame member is located adjacent the second inwardly accessible accessory slot of the fourth side frame member;
wherein the second outwardly accessible accessory slot of the fourth side frame member includes an opening that extends the longitudinal extent of the fourth side frame member and has a width less than a width of the second outwardly accessible accessory slot of the fourth side frame member;
wherein the second inwardly accessible accessory slot of the fourth side frame member includes an opening that extends the longitudinal extent of the fourth side frame member and has a width less than a width of the second inwardly accessible accessory slot of the fourth side frame member;
wherein the opening of the second outwardly accessible accessory slot of the fourth side frame member is positioned on an opposite side of the fourth side frame member from the opening of the second inwardly accessible accessory slot of the fourth side frame member;
a third upwardly extending corner pillar that includes an outwardly accessible accessory slot that extends a longitudinal extent of the third upwardly extending corner pillar;
wherein the outwardly accessible accessory slot of the third upwardly extending corner pillar is bounded by a first inwardly accessible accessory slot that extends the longitudinal extent of the third upwardly extending corner pillar and a second inwardly accessible accessory slot that extends the longitudinal extent of the third upwardly extending corner pillar;
wherein the first inwardly accessible accessory slot of the third upwardly extending corner pillar and the second inwardly accessible accessory slot of the third upwardly extending corner pillar are located on an opposing side from the outwardly accessible accessory slot of the third upwardly extending corner pillar;
wherein the third side frame member is spaced apart from the fourth side frame member and are both located adjacent the third upwardly extending corner pillar;
a fourth upwardly extending corner pillar that includes an outwardly accessible accessory slot that extends a longitudinal extent of the fourth upwardly extending corner pillar;
wherein the outwardly accessible accessory slot of the fourth upwardly extending corner pillar is bounded by a first inwardly accessible accessory slot that extends the longitudinal extent of the fourth upwardly extending corner pillar and a second inwardly accessible accessory slot that extends the longitudinal extent of the fourth upwardly extending corner pillar;
wherein the first inwardly accessible accessory slot of the fourth upwardly extending corner pillar and the second inwardly accessible accessory slot of the fourth upwardly extending corner pillar are located on an opposing side from the outwardly accessible accessory slot of the fourth upwardly extending corner pillar;
wherein the third side frame member and the fourth side frame member are both located adjacent the fourth upwardly extending corner pillar;
a longitudinally extending first end frame member that includes an outwardly accessible accessory slot that extends a longitudinal extent of the first end frame member;
wherein the outwardly accessible accessory slot of the first end frame member is bounded by a first inwardly accessible accessory slot that extends the longitudinal extent of the first end frame member and a second inwardly accessible accessory slot that extends the longitudinal extent of the first end frame member;
wherein the outwardly accessible accessory slot of the first end frame member is located on an opposing side of the first inwardly accessible accessory slot of the first end frame member and the second inwardly accessible accessory slot of the first end frame member;
wherein the second upwardly extending corner pillar is located adjacent to the first end frame member;
wherein the third upwardly extending corner pillar is located adjacent to the first end frame member opposite the second upwardly extending corner pillar; and
a longitudinally extending second end frame member that includes an outwardly accessible accessory slot that extends a longitudinal extent of the second end frame member;
wherein the outwardly accessible accessory slot of the second end frame member is bounded by a first inwardly accessible accessory slot that extends the longitudinal extent of the second end frame member and a second inwardly accessible accessory slot that extends the longitudinal extent of the second end frame member;
wherein the outwardly accessible accessory slot of the second end frame member is located on an opposing side of the first inwardly accessible accessory slot of the second end frame member and the second inwardly accessible accessory slot of the second end frame member;
wherein the fourth upwardly extending corner pillar is located adjacent to the second end frame member; and
wherein the first upwardly extending corner pillar is located adjacent to the second end frame member opposite the fourth upwardly extending corner pillar.

2. The cargo box frame assembly of claim 1, wherein the first side frame member and the third side frame member each have a base configured to set on top of a sidewall of the cargo box.

3. The cargo box frame assembly of claim 1, wherein the outwardly accessible accessory slot and the inwardly accessible accessory slot of the second side frame member are located transverse to the second outwardly accessible accessory slot and the second inwardly accessible accessory slot of the second side frame member.

4. The cargo box frame assembly of claim 1, wherein the outwardly accessible accessory slot and the inwardly accessible accessory slot of the fourth side frame member are located transverse to the second outwardly accessible accessory slot and the second inwardly accessible accessory slot of the fourth side frame member.

5. The cargo box frame assembly of claim 1, wherein the second upwardly extending corner pillar is connectable to the first end frame member and the third upwardly extending corner pillar is connectable to the first end frame member opposite the second upwardly extending corner pillar.

6. The cargo box frame assembly of claim 1, wherein the fourth upwardly extending corner pillar is connectable to the second end frame member and the first upwardly extending corner pillar is connectable to the second end frame member opposite the fourth upwardly extending corner pillar.

7. The cargo box frame assembly of claim 1, wherein the first side frame member and the third side frame member are each a base frame member.

8. The cargo box frame assembly of claim 1, wherein the second side frame member and the fourth side frame member are each a top frame member.

9. The cargo box frame assembly of claim 1, wherein the outwardly accessible accessory slot and the inwardly accessible accessory slot both of the first side frame member share a common wall.

10. The cargo box frame assembly of claim 1, wherein each of the outwardly accessible accessory slot and the inwardly accessible accessory slot from each of the first side frame member, the second side frame member, the third side frame member, and the fourth side frame member are configured to receive a respective movable block wherein the movable block disposed in the outwardly accessible accessory slot is attachable to a bracket and the movable block disposed within the inwardly accessible accessory slot is attachable to a truck cap panel member.

11. The cargo box frame assembly of claim 1, wherein the outwardly accessible accessory slot and the inwardly accessible accessory slot of the first side frame member are located at least about parallel to the outwardly accessible accessory slot and the inwardly accessible accessory slot of the second side frame member.

12. The cargo box frame assembly of claim 1, wherein the second side frame member and the fourth side frame member each includes a support panel extending from the second inwardly accessible accessory slot of the second side frame member and the fourth side frame member, respectively.

13. The cargo box frame assembly of claim 1, wherein the first end frame member and the second end frame member each includes a support panel extending from the second inwardly accessible accessory slot of the first end frame member and the second end frame member, respectively.

14. A cargo box frame assembly configured to set on top of a cargo box of a pickup truck, the cargo box frame assembly comprising:
a longitudinally extending first side frame member that includes an outwardly accessible accessory slot that extends a longitudinal extent of the first side frame member and an inwardly accessible accessory slot that extends the longitudinal extent of the first side frame member;
wherein the outwardly accessible accessory slot of the first side frame member is located adjacent the inwardly accessible accessory slot of the first side frame member;
wherein the outwardly accessible accessory slot of the first side frame member includes an opening that extends the longitudinal extent of the first side frame member and has a width less than a width of the outwardly accessible accessory slot of the first side frame member;
wherein the inwardly accessible accessory slot of the first side frame member includes an opening that extends the longitudinal extent of the first side frame member and has a width less than a width of the inwardly accessible accessory slot of the first side frame member;
wherein the opening of the outwardly accessible accessory slot of the first side frame member is positioned on an opposite side of the first side frame member from the opening of the inwardly accessible accessory slot of the first side frame member;
a longitudinally extending second side frame member that includes an outwardly accessible accessory slot that extends a longitudinal extent of the second side frame member and an inwardly accessible accessory slot that extends the longitudinal extent of the second side frame member;
wherein the outwardly accessible accessory slot of the second side frame member is located adjacent the inwardly accessible accessory slot of the second side frame member;
wherein the outwardly accessible accessory slot of the second side frame member includes an opening that extends the longitudinal extent of the second side frame member and has a width less than a width of the outwardly accessible accessory slot of the second side frame member;
wherein the inwardly accessible accessory slot of the second side frame member includes an opening that extends the longitudinal extent of the second side frame member and has a width less than a width of the inwardly accessible accessory slot of the second side frame member;
wherein the opening of the outwardly accessible accessory slot of the second side frame member is positioned on an opposite side of the second side frame member from the opening of the inwardly accessible accessory slot of the second side frame member;
wherein the longitudinally extending second side frame member includes a second outwardly accessible accessory slot that extends the longitudinal extent of the second side frame member and a second inwardly accessible accessory slot that extends the longitudinal extent of the second side frame member;
wherein the second outwardly accessible accessory slot of the second side frame member is located adjacent the second inwardly accessible accessory slot of the second side frame member;
wherein the second outwardly accessible accessory slot of the second side frame member includes an opening that extends the longitudinal extent of the second side frame member and has a width less than a width of the second outwardly accessible accessory slot of the second side frame member;
wherein the second inwardly accessible accessory slot of the second side frame member includes an opening that extends the longitudinal extent of the second side frame member and has a width less than a width of the second inwardly accessible accessory slot of the second side frame member; and
wherein the opening of the second outwardly accessible accessory slot of the second side frame member is positioned on an opposite side of the second side frame member from the opening of the second inwardly accessible accessory slot of the second side frame member.

15. The cargo box frame assembly of claim 14, further comprising a first upwardly extending corner pillar that includes an outwardly accessible accessory slot that extends a longitudinal extent of the first upwardly extending corner pillar;
wherein the outwardly accessible accessory slot of the first upwardly extending corner pillar is bounded by a first inwardly accessible accessory slot that extends the longitudinal extent of the first upwardly extending corner pillar and a second inwardly accessible accessory slot that extends the longitudinal extent of the first upwardly extending corner pillar;
wherein the first inwardly accessible accessory slot of the first upwardly extending corner pillar and the second inwardly accessible accessory slot of the first upwardly extending corner pillar are located on an opposing side from the outwardly accessible accessory slot of the first upwardly extending corner pillar;
wherein the first side frame member is spaced apart from the second side frame member and are both located adjacent the first upwardly extending corner pillar;
a second upwardly extending corner pillar that includes an outwardly accessible accessory slot that extends a longitudinal extent of the second upwardly extending corner pillar;
wherein the outwardly accessible accessory slot of the second upwardly extending corner pillar is bounded by a first inwardly accessible accessory slot that extends the longitudinal extent of the second upwardly extending corner pillar and a second inwardly accessible accessory slot that extends the longitudinal extent of the second upwardly extending corner pillar;
wherein the first inwardly accessible accessory slot of the second upwardly extending corner pillar and the second inwardly accessible accessory slot of the second upwardly extending corner pillar are located on an opposing side from the outwardly accessible accessory slot of the second upwardly extending corner pillar; and
wherein the first side frame member and the second side frame member are both located adjacent the second upwardly extending corner pillar.

16. The cargo box frame assembly of claim 15, further comprising a longitudinally extending third side frame member that includes an outwardly accessible accessory slot that extends a longitudinal extent of the third side frame member and an inwardly accessible accessory slot that extends the longitudinal extent of the third side frame member;
wherein the outwardly accessible accessory slot of the third side frame member is located adjacent the inwardly accessible accessory slot of the third side frame member;
wherein the outwardly accessible accessory slot of the third side frame member includes an opening that extends the longitudinal extent of the third side frame member and has a width less than a width of the outwardly accessible accessory slot of the third side frame member;
wherein the inwardly accessible accessory slot of the third side frame member includes an opening that extends the longitudinal extent of the third side frame member and has a width less than a width of the inwardly accessible accessory slot of the third side frame member;
wherein the opening of the outwardly accessible accessory slot of the third side frame member is positioned on an opposite side of the third side frame member from the opening of the inwardly accessible accessory slot of the third side frame member;
a longitudinally extending fourth side frame member that includes an outwardly accessible accessory slot that extends a longitudinal extent of the fourth side frame member and an inwardly accessible accessory slot that extends the longitudinal extent of the fourth side frame member;
wherein the outwardly accessible accessory slot of the fourth side frame member is located adjacent the inwardly accessible accessory slot of the fourth side frame member;
wherein the outwardly accessible accessory slot of the fourth side frame member includes an opening that extends the longitudinal extent of the fourth side frame member and has a width less than a width of the outwardly accessible accessory slot of the fourth side frame member;
wherein the inwardly accessible accessory slot of the fourth side frame member includes an opening that extends the longitudinal extent of the fourth side frame member and has a width less than a width of the inwardly accessible accessory slot of the fourth side frame member;
wherein the opening of the outwardly accessible accessory slot of the fourth side frame member is positioned on an opposite side of the fourth side frame member from the opening of the inwardly accessible accessory slot of the fourth side frame member;
wherein the fourth side frame member includes a second outwardly accessible accessory slot that extends a longitudinal extent of the fourth side frame member and a second inwardly accessible accessory slot that extends the longitudinal extent of the fourth side frame member;
wherein the second outwardly accessible accessory slot of the fourth side frame member is located adjacent the second inwardly accessible accessory slot of the fourth side frame member;
wherein the second outwardly accessible accessory slot of the fourth side frame member includes an opening that extends the longitudinal extent of the fourth side frame member and has a width less than a width of the second outwardly accessible accessory slot of the fourth side frame member;
wherein the second inwardly accessible accessory slot of the fourth side frame member includes an opening that extends the longitudinal extent of the fourth side frame member and has a width less than a width of the second inwardly accessible accessory slot of the fourth side frame member; and
wherein the opening of the second outwardly accessible accessory slot of the fourth side frame member is positioned on an opposite side of the fourth side frame member from the opening of the second inwardly accessible accessory slot of the fourth side frame member.

17. The cargo box frame assembly of claim 16, further comprising a third upwardly extending corner pillar that includes an outwardly accessible accessory slot that extends a longitudinal extent of the third upwardly extending corner pillar;
wherein the outwardly accessible accessory slot of the third upwardly extending corner pillar is bounded by a first inwardly accessible accessory slot that extends the longitudinal extent of the third upwardly extending corner pillar and a second inwardly accessible accessory slot that extends the longitudinal extent of the third upwardly extending corner pillar;
wherein the first inwardly accessible accessory slot of the third upwardly extending corner pillar and the second inwardly accessible accessory slot of the third upwardly extending corner pillar are located on an opposing side from the outwardly accessible accessory slot of the third upwardly extending corner pillar;
wherein the third side frame member is spaced apart from the fourth side frame member and are both located adjacent the third upwardly extending corner pillar;
a fourth upwardly extending corner pillar that includes an outwardly accessible accessory slot that extends a longitudinal extent of the fourth upwardly extending corner pillar;
wherein the outwardly accessible accessory slot of the fourth upwardly extending corner pillar is bounded by a first inwardly accessible accessory slot that extends the longitudinal extent of the fourth upwardly extending corner pillar and a second inwardly accessible accessory slot that extends the longitudinal extent of the fourth upwardly extending corner pillar;
wherein the first inwardly accessible accessory slot of the fourth upwardly extending corner pillar and the second inwardly accessible accessory slot of the fourth upwardly extending corner pillar are located on an opposing side from the outwardly accessible accessory slot of the fourth upwardly extending corner pillar; and
wherein the third side frame member and the fourth side frame member are both located adjacent the fourth upwardly extending corner pillar.

18. The cargo box frame assembly of claim 17, further comprising a longitudinally extending first end frame member that includes an outwardly accessible accessory slot that extends a longitudinal extent of the first end frame member;
wherein the outwardly accessible accessory slot of the first end frame member is bounded by a first inwardly accessible accessory slot that extends the longitudinal extent of the first end frame member and a second inwardly accessible accessory slot that extends the longitudinal extent of the first end frame member;
wherein the outwardly accessible accessory slot of the first end frame member is located on an opposing side of the first inwardly accessible accessory slot of the first end frame member and the second inwardly accessible accessory slot of the first end frame member;
wherein the second upwardly extending corner pillar is located adjacent to the first end frame member; and
wherein the third upwardly extending corner pillar is located adjacent to the first end frame member opposite the second upwardly extending corner pillar.

19. A cargo box frame assembly configured to set on top of a cargo box of a pickup truck, the cargo box frame assembly comprising:
a longitudinally extending frame member that includes an outwardly accessible accessory slot and an inwardly accessible accessory slot;
wherein the outwardly accessible accessory slot of a first side frame member is located adjacent the inwardly accessible accessory slot of the first side frame member;
wherein the outwardly accessible accessory slot of the first side frame member includes an opening;
wherein the inwardly accessible accessory slot of the first side frame member includes an opening; and
wherein the opening of the outwardly accessible accessory slot of the first side frame member is positioned on an opposite side of the first side frame member from the opening of the inwardly accessible accessory slot of the first side frame member.

20. The cargo box frame assembly of claim 19, wherein the opening of the outwardly accessible accessory slot has a width less than a width of the outwardly accessible accessory slot, wherein the opening of the inwardly accessible accessory slot has a width less than a width of the inwardly accessible accessory slot, and wherein the opening of the outwardly accessible accessory slot is positioned on an opposite side of the first side frame member from the opening of the inwardly accessible accessory slot.
